(19) United States
(12) Patent Application Publication
(10) Pub. No.: US 2011/0054958 A1
(43) Pub. Date: Mar. 3, 2011

(54) Method and Apparatus for Automatically Reconfiguring Tooling Based on Downloaded Solution Asset Classification, Decompisition and Semantics

(75) Inventors: Raphael P. Chancey, Leander, TX (US); Eduardo T. Kahan, Longwood, FL (US)

(73) Assignee: International Business Machines Corporation, Armonk, NY (US)

(21) Appl. No.: 12/546,841

(22) Filed: Aug. 25, 2009

(51) Int. Cl. G06Q 10/00; G06F 3/048

(52) U.S. Cl. 705/7; 715/810

(57) ABSTRACT

Provided is a method for the management of actionable assets with respect to a computing solution. Assets and corresponding artifacts are located and downloaded from a tool repository and incorporated into existing computing tooling. The repository may be located on any computing system connected to an appropriately configured host system via a network such as a local area network (LAN) or the Internet. Downloaded assets are analyzed and parsed into corresponding artifacts. The asset is disassembled into the corresponding artifacts and loaded into the computing tooling. The tooling is then reconfigured with respect to the newly loaded asset and artifacts. Reconfiguration may, but is not limited to, the reconfiguration of palettes, menus and auto model loading. Automatic reconfiguration of the tooling is also executed based upon the availability of the asset the asset type and classification of the asset.

### BACKGROUND

1. Technical Field

The claimed subject matter relates generally to computing tools and, more specifically, to a method for accessing, downloading and integrating computing assets and artifacts into programming tools.

2. Description of the Related Art

The introduction of computer networks and, more recently, the Internet have increased the availability of many type of computing resources. A potential resource for a computing solution may be located and downloaded from a large number of different locations, or repositories, typically connected to the local computing system via one or more networks. One example of a system typically employed to implement this task is a remote access service, or RAS. A RAS is a combination of hardware and software that enables a user or application to access computing tools and/or information, or assets, stored on a network of processing devices.

In addition to needing information about many different possible locations for resources, a user must have operational information about potential assets. For example, an asset may be comprised of multiple components, or “artifacts.” A particular user may need only specific artifacts of a component and needs knowledge of both the artifacts that comprise a particular asset but how to use the asset and artifacts. One example of an industry standard for describing computing assets is Reusable Access Specification, which provides a detailed description of assets using metadata.

Of course, the downloading of remotely located assets comes with an array of issues that must be addressed prior to implementation. A remote asset and the corresponding artifacts typically must be located, downloaded and analyzed prior to being integrated and used in an existing computing product. This often requires the user to be very familiar with the asset and corresponding artifacts. In addition, the user must be familiar with how to use the asset and artifacts as well as how to integrate the asset into an existing product. Currently, users are on their own with regard to asset and artifact reuse.

### SUMMARY OF THE CLAIMED SUBJECT MATTER

Provided is an Asset and Artifact Download and Integration Device (AADID) and method for the management of actionable assets with respect to a computing solution. Assets and corresponding artifacts are located and downloaded from a tool repository, such as a remote access service (RAS) repository, and incorporated into existing computing tooling, such as RAS. Assets and corresponding artifacts may be described using Reusable Access Specification. The repository may be located on any computing system connected to an appropriately configured host system via a network such as a local area network (LAN) or the Internet.

Downloaded, actionable assets are analyzed and parsed into corresponding artifacts. Throughout the Specification, an “actionable” asset is one that is automatically incorporated into existing tooling in accordance with the claimed subject matter. The AADID determines whether or not the asset is an operational model asset type. If so, tasks associated with the asset type are executed. The asset is automatically disassembled into the corresponding artifacts and loaded into the computing tooling. The tooling is then reconfigured with respect to the newly loaded asset and artifacts. For example, palettes, menus and auto model loading are reconfigured based upon user selection and configuration of the downloaded assets and artifacts. Automatic reconfiguration of the tooling is also executed based upon the availability of the asset the asset type and classification of the asset.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE FIGURES

A better understanding of the claimed subject matter can be obtained when the following detailed description of the disclosed embodiments is considered in conjunction with the following figures, in which:

FIG. 1 is a block diagram of one example of a computing system architecture that supports the claimed subject matter.

FIG. 2 is a block diagram of an example of a computing asset that is managed by means of the claimed subject matter.

FIG. 3 is a block diagram of a window employed in one implementation of the disclosed technology.

FIG. 4 is a block diagram of the window of FIG. 3, showing an additional window used in conjunction with the disclosed technology.

FIG. 5 is a block diagram of the window of FIGS. 3 and 4, showing additional displays used in conjunction with the disclosed technology.

FIG. 6 is a flowchart of a Reconfigure Tooling process that implements one aspect of the claimed subject matter.

### DETAILED DESCRIPTION OF THE FIGURES

Although described with particular reference to a remote asset service (RAS), the claimed subject matter can be implemented in any information technology (IT) system in which the management and integration of remote components and assets are desirable. Those with skill in the computing arts will recognize that the disclosed embodiments have relevance to a wide variety of computing environments in addition to those described below. In addition, the methods of the disclosed technology can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any physical means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for remote asset management and integration. The term “programmed method”, as used herein, is defined to mean one or more process steps that are presently performed; or, alternatively, one or more process steps that are enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

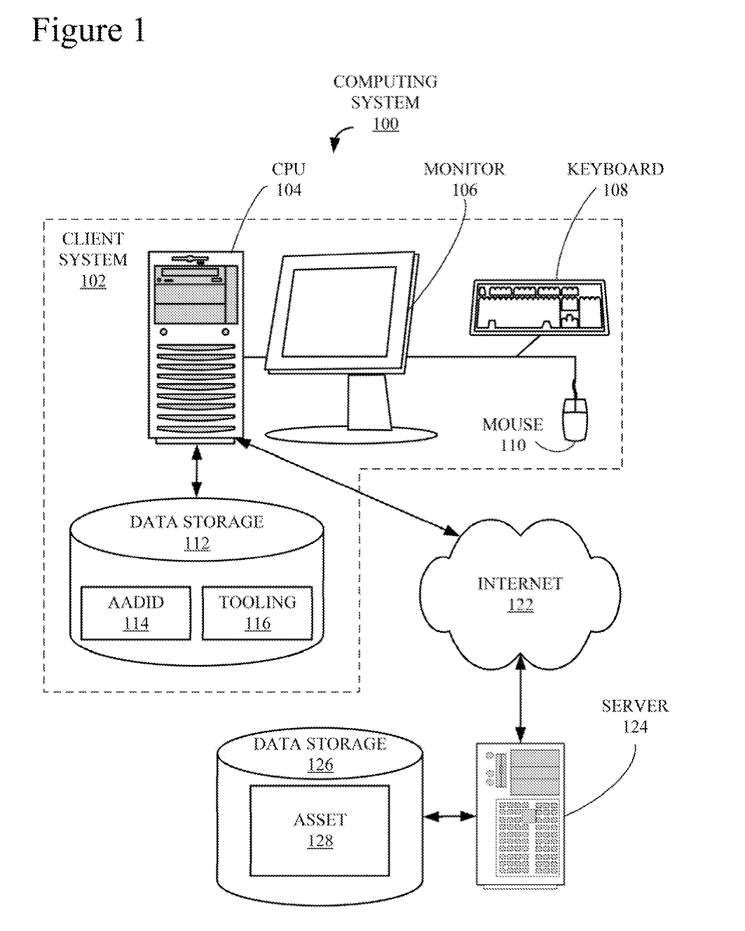

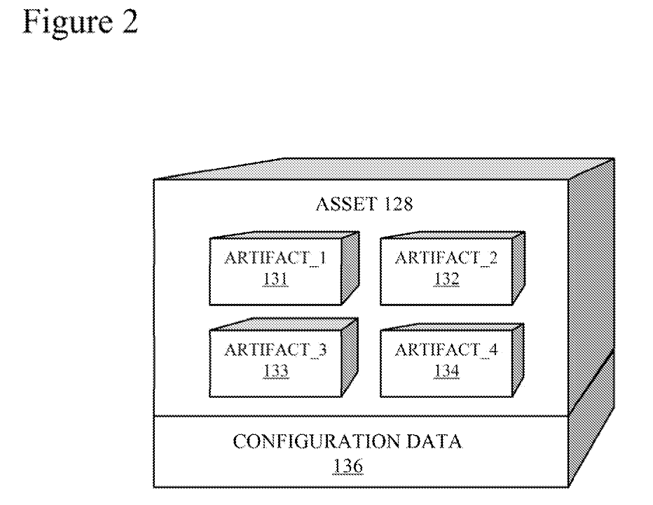

Turning now to the figures, FIG. 1 is a block diagram of one example of a computing system architecture 100 that supports the claimed subject matter. A client system 102 includes a central processing unit (CPU) 104, coupled to a monitor 106, a keyboard 108 and a mouse 110, which together facilitate human interaction with computing system 100 and client system 102. Also included in client system 102 and attached to CPU 104 is a data storage component 112, which may,either be incorporated into CPU 104 i.e. an internal device, or attached externally to CPU 104 by means of various, commonly available connection devices such as but not limited to, a universal serial bus (USB) port (not shown). Data storage 112 is illustrated storing one example of a Asset and Artifact Download and Integration Device (AADID) 114 that incorporates the claimed subject matter and a tooling module 116 that is an example of tooling that takes advantage of the capabilities of AADID 114. AADID 114 is described in more detail below in conjunction with FIGS. 2-6.

Client system 102 and CPU 104 are connected to Internet 122, which is also connected to a server computer 124. Although not show for the sale of simplicity, server 124 includes a CPU, a monitor, a keyboard and a mouse, like components 104, 106, 108 and 110. Server 124 is coupled to data storage 126, which like data storage 112 is available in many possible configurations. Data storage is illustrated storing an asset 128, which is an example of an asset available to tooling 116 via AADID 114. Asset 128 is described in more detail below in FIG. 2.

Although in this example, client system 102 and server 124 are communicatively coupled via Internet 122, they could also be coupled through any number of communication mediums such as, but not limited to, a local area network (LAN) (not shown). Further, it should be noted there are many possible computing system configurations, of which computing system 100 is only one simple example.

FIG. 2 is a block diagram of an example of computing asset 128, first introduced in conjunction with FIG. 1, which is managed by means of the claimed subject matter. Asset 128 includes several components, or “artifacts,” an artifact_1 131, an artifact_2 132, an artifact_3 133 and an artifact_4 134. An artifact is any item that provides functionality to the corresponding asset, such as, but is not limited to, items software, hardware and documentation. Also included in asset 128 is a configuration data module 130. Configuration data includes information required to utilize asset 128 and artifacts 131-134. Examples of configuration data corresponding to a particular asset include, but are not limited to, an asset classification, a solution for which the asset is designed or configured, a typical or preferred usage corresponding to the asset and other assets related to the particular asset.

Assets may be any computing tool or artifact associated with a computing solution. For example, in a retail environment, assets may include, but are not limited to, data servers, application servers, point-of-sale (POS) terminals, networks, adapters for communication with third party such as credit card companies, documentation as well as a design diagram of the business solution. It should be understood that any particular business solution typically includes many assets and types of assets. In addition, different business operations may share a need for particular assets or types of assets. The disclosed technology enables a developer to take advantage of work for one client to develop a model for another client by providing access to assets that meet similar requirements from business to business.

Asset 128 is a simple example used in the following description. A typical system would have many assets and a typical asset could have many more artifacts but for the sake of simplicity only one (1) asset and four (4) artifacts are illustrated. In addition, in an alternative embodiment, configuration data is associated with each artifact 131-134 rather than with asset 128.

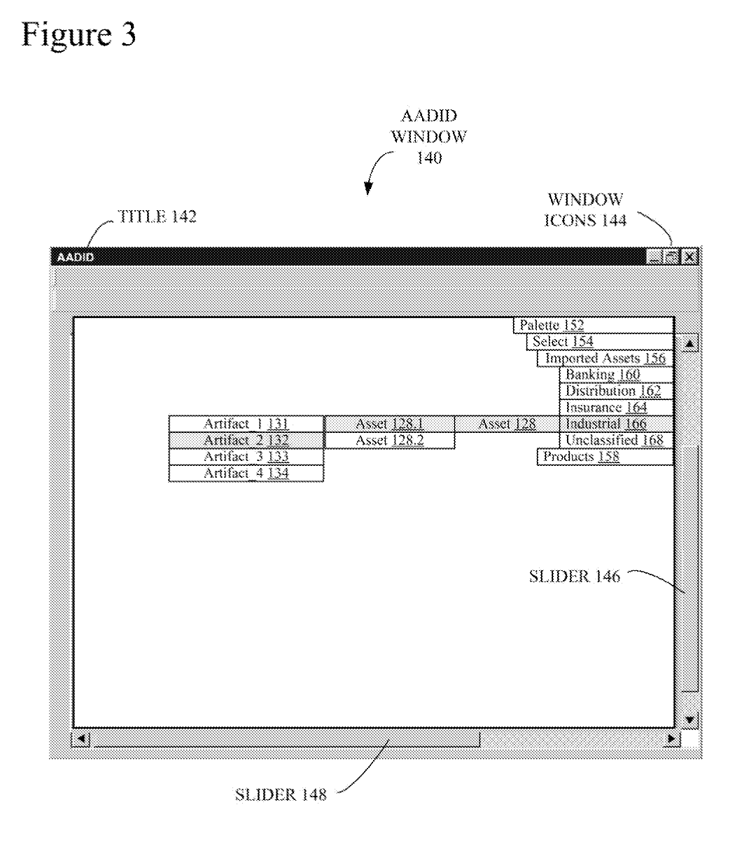

FIG. 3 is a block diagram of a model management, or AADID, window 140 employed in one implementation of the disclosed technology. In this example, window 140 is displayed on monitor 106 of client system 102 in conjunction with execution of AADID 114 (FIG. 1). Window 140 is illustrated with several standard window devices such as a title bar 142, window icons 144 for controlling the size and display characteristics of window 140 and slider bars 146 and 148 to control the portion of window 140 that is displayed at any particular time. Title 142, window icons 144 and sliders 146 and 148 should be familiar to those with experience in the use of a graphical user interface (GUI).

Window 140 displays several menu choices, specifically a Palette 152, which includes a Select option 154 for choosing identified assets. Two types of assets illustrated in this example are an Imported Assets 156 and a Products 158. Under imported assets 156 are banking assets 160, Distribution assets 162, Insurance assets 164 Industrial assets 166 and Unclassified assets 168, which are assets that either don't fit into one of the other assets 160, 162, 164 or 166 or apply to multiple types of assets. In this example, a user has highlighted Industrial assets 166 to indicate an interest in downloading assets and corresponding artifacts from that particular category.

Also highlighted is a listing, or menu choice, for asset 128 (FIGS. 1 and 2) Asset 128 is employed as one example of an asset included within industrial assets 166. As explained above, a typical category would have multiple assets. Asset 128 is shown as including two (2) versions, i.e. an asset 128.1 and an asset 128.2, of which asset 128.1 is highlighted, or selected, by the user. Asset 128.1 includes listings of artifacts_1 131, artifacts_2 132, artifacts_3 133 and artifacts_4 134, all introduced above in conjunction with FIG. 2. In this example artifact_2 132 is highlighted, indicating that the user is selecting artifact_2 132 for inclusion in associated tooling 116 (FIG. 1). It should be understood that the claimed subject matter enables the user to select either an entire asset and all corresponding, artifacts or specific artifacts within an asset.

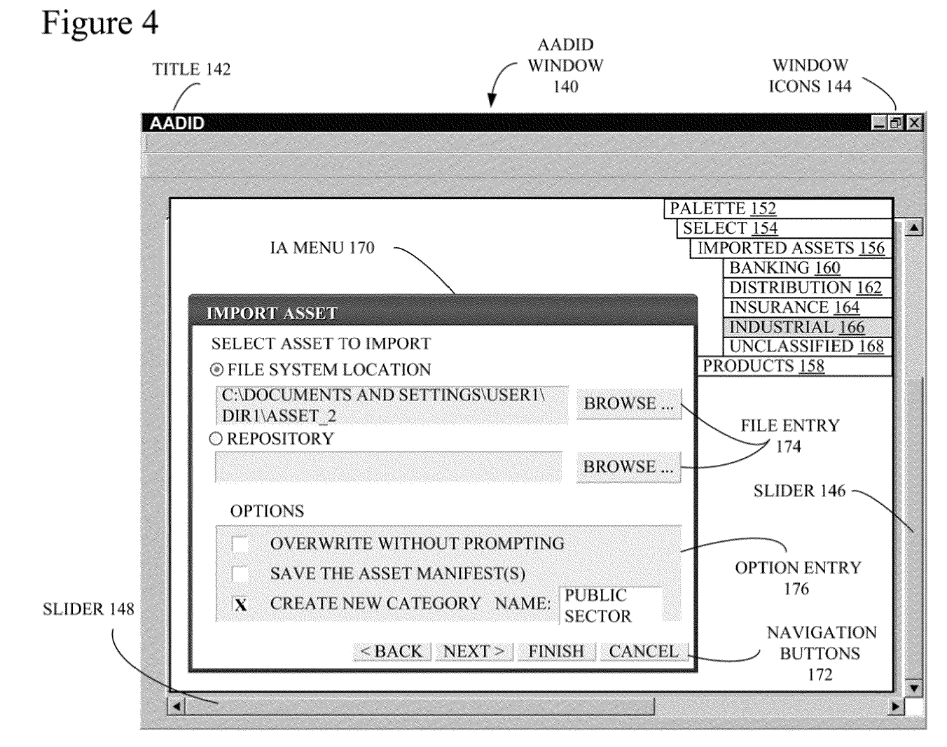

FIG. 4 is a block diagram of AADID window 140, showing title bar 142, window icons 144, sliders 146 and 148, and menu choices 152, 154, 156, 158, 160, 162, 164, 166 and 168, all introduced above in conjunction with FIG. 3. Also illustrated is an additional Import Asset (IA) menu window 170 employed in conjunction with the disclosed technology. IA window 170 includes navigation buttons 172, which should be familiar to those with skill in the computing arts, a file entry section 174 and an option entry section 176.

File entry section 174 provides two methods for locating an asset: 1) a file system location method that enables a user enters a file path to a specific asset or artifact; and 2) a repository method that enables a user to select an asset or artifact from a specified asset repository. In this example, asset_2 132 (FIG. 2) is listed in file system location text box because asset_2 132 was specified by virtue of being highlighted in AADID window 140 above in FIG. 3.

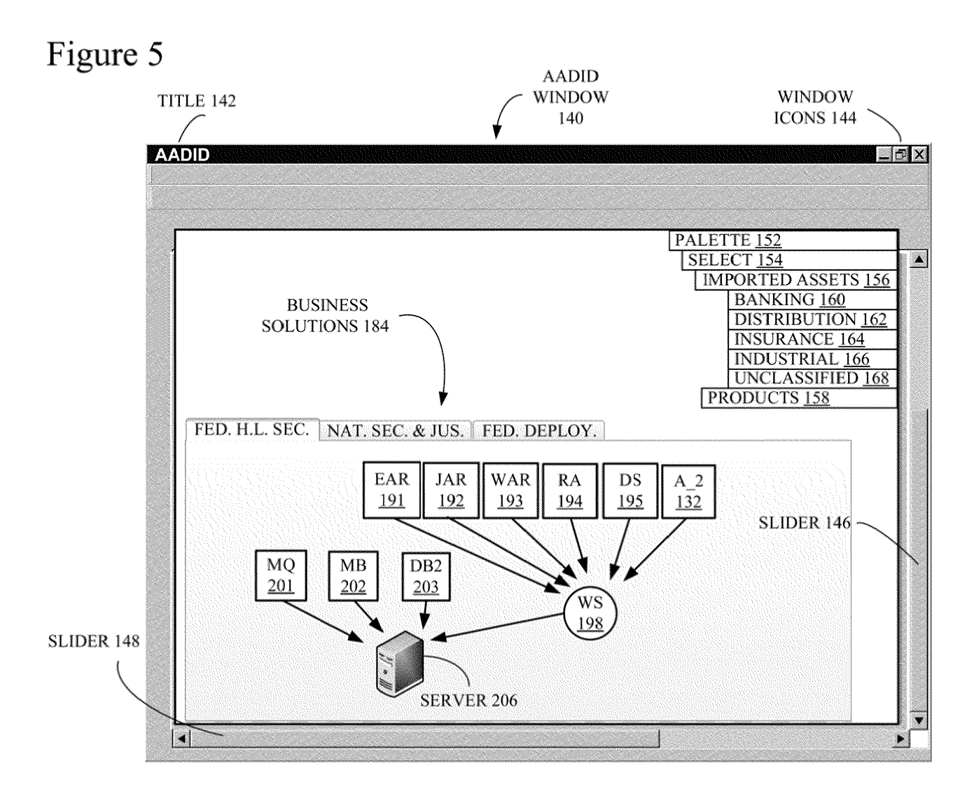

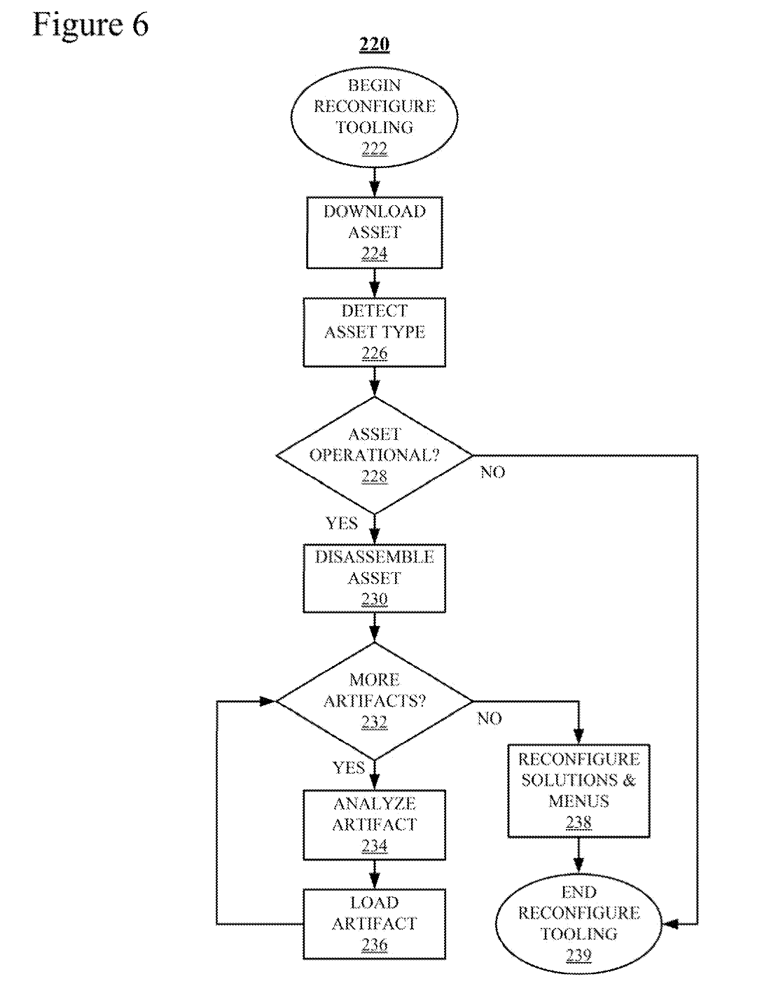

Option entry section 176 illustrates several examples of options that may be associated with the selection of a particular asset or artifact in conjunction with IA window 170. Option include, but are not limited to, an “Overwrite Without Prompting” (OWP) option, a “Save the Asset Manifest(s)” (SAM) option and a “Create New Category” (CNC) option. OWP option controls whether or not the selection of a new asset or artifact that replaces and old asset or artifact displays a warning to that effect. SAM option controls whether or not a log file is produced. CNC option controls whether or not a selected asset or artifact is installed in a new category in, with respect to this example, palette 152. In this example, CNC option is selected and the name assigned to the new category to be created is entitled “Public Sector.” Functionality associated with CNC option is explained in more detail below in conjunction with FIGS. 5 and 6.

FIG. 5 is another diagram of AADID window 140, showing title bar 142, window icons 144, sliders 146 and 148, and menu choices 152, 154, 156, 158, 160, 162, 164, 166 and 168, all introduced above in conjunction with FIG. 3. In this example, the specification of new category, as specified by the ‘X’ in CNC option of option entry 176 (FIG. 4) corresponding to the selection of asset_2 132 (FIGS. 2 and 4) in file entry box 174 (FIG. 4) of IA window 170 (FIG. 4) has generated a new menu option, i.e. “Public Sector” 182.

AADID 140 also displays three (3) representative business solutions 184, i.e. a “Federal Homeland Security” (FHS) tab, a “National Security and Justice” tab and a “Federal Deployment” tab. In this example, detail associated with Federal Homeland Security tab is illustrated. FHS solution includes examples of various assets, i.e. an Enterprise Archive (EAR) asset 191, a JAVA® archive (JAR) asset 192, a web archive (WAR) asset 193, resource adaptor (RA) asset 194, a data source (DS) asset 195 and artifact_2 (A_2) 132 (FIG. 2). Assets 132 and 191-195 are incorporated into a websphere (WS) 198, which is included with a message queueing (MQ) component 201, a message broker (MB) component 202 and a database (DB2) component 203 to constitute a business solution loaded onto a server 206. It should be noted that the disclosed techniques have seamlessly incorporated model assets into both menu choices 152, 154, 156, 158. 160, 162, 164, 166 and 168 and business solutions 184.

FIG. 6 is a flowchart of a Reconfigure Tooling process 220 that implements the claimed subject matter. In this example, process 220 is stored on data storage 112 (FIG. 1) in conjunction with AADID 114 (FIG. 1) and executed on CPU 104 (FIG. 1) of client system 102 (FIG. 1). Process 220 starts in a “Begin Reconfigure Tooling” block 222 and proceeds immediately to a “Download Asset” block 224.

During block 224, a user specifies a particular asset (see asset 128, FIGS. 1 and 1) for inclusion into computing tools (see tooling 116 FIG. 1 and business solutions 184, FIG. 5). During an “Detect Asset Type” block 226, process 220 examines configuration data (see configuration data 136, FIG. 2) associated with a selected asset. During an “Asset Operational?” block 228, process 220 determines whether or not the configuration data associated with the asset downloaded during block 224 is an operation model asset type. If so, process 220 proceeds to a “Disassemble Asset” block 230 during which the downloaded asset is disassembled into the component parts (see artifacts 131-134, FIG. 2).

During a “More Artifacts?” block 232, process 220 determines whether or not there are unprocessed artifacts to analyze and process. If so, during an “Analyze Artifact” block 234, process 220 analyzes both the configuration data associated with the downloaded artifact and the options entry data (see options entry 176, FIG. 4) to determine the appropriate actions to take. Actions include but are not limited to, modifying an asset to conform to a particular business solution and to integrate with other assets.

During a “Load Artifact” block 236, process 220 incorporates the artifact into the appropriate tooling based upon the information gathered during block 234. Process 220 then returns to block 232 to process the next artifact in the downloaded asset and processing continues as described above. If, during block 232, process 220 determines that all artifacts associated with the downloaded asset have been processed, control proceeds to a “Reconfigure Solutions and Menus” block 238. During block 238, process 220 executes, if necessary, reconfiguration of affected business solutions (see business solutions 184) based upon the artifacts loaded during block 236 and updates menus (see menus items 152, 154, 156, 158, 160, 162, 164, 166 and 168, FIGS. 3-5). It should be understood that under some circumstances, process 220 may determine during block 238 that reconfiguration is not necessary. Following block 238 or, if during block 228, process 220 determines that the asset downloaded during block 226 is not operational, control proceeds to an “End Reconfigure Tooling” block 239 in which process 220 is complete.

While the claimed subject matter has been shown and described with reference to particular embodiments thereof, it will be understood by those skilled in the art that the foregoing and other changes in form and detail may be made therein without departing from the spirit and scope of the claimed subject matter, including but not limited to additional, less or modified elements and/or additional, less or modified blocks performed in the same or a different order.

We claim:

1. A method for business solution asset reconfiguration, comprising:
identifying an asset for incorporation into a business model;
downloading the asset from an asset repository;
disassembling the asset into a plurality of artifacts;
identifying an artifact of the plurality of artifacts for inclusion into the business model;
reconfiguring the business model to conform with the inclusion of the identified artifact;
incorporating the identified artifact into a business solution represented by the business model; and
transmitting a representation of the business solution to a display.

2. The method of claim 1, further comprising:
determining whether or not the downloaded asset is an operational model asset type;
if the asset is an operational model asset type, performing the disassembling, identifying, reconfiguring and incorporating; and
otherwise, if the asset is not an operational model asset type, not performing the disassembling, identifying, reconfiguring and incorporating.

3. The method of claim 1 wherein the plurality of artifacts are software, hardware and documentation corresponding to software and hardware.

4. The method of claim 1, wherein the plurality of assets are adapters to enable the business solution to access a third party vendor.

5. The method of claim 1, wherein the plurality of assets are defined by reusable asset specification.

6. The method of claim 1, further comprising updating menus and pallets associated with the tooling in conjunction with the reconfiguration of the tooling.

7. The method of claim 1, wherein the assets repository is a remote access service (RAS) repository.

8. A system for business solution asset reconfiguration, comprising:
a memory;
a processor coupled to the memory;
a display; and
logic, stored on the memory for execution on the processor, for:
identifying an asset for incorporation into a business model;
downloading the asset from an asset repository;
disassembling the asset into a plurality of artifacts;
identifying an artifact of the plurality of artifacts for inclusion into the business model;
reconfiguring the business model to conform with the inclusion of the identified artifact;
incorporating the identified artifact into a business solution represented by the business model; and
transmitting a representation of the business solution to the display.

9. The system of claim 8, further comprising logic, stored on the memory for execution on the processor, for:
determining whether or not the downloaded asset is an operational model asset type;
if the asset is an operational model asset type, performing the disassembling, identifying, reconfiguring and incorporating; and
otherwise, if the asset is not an operational model asset type, not performing the disassembling, identifying, reconfiguring and incorporating.

10. The system of claim 8, the plurality of artifacts comprising:
software:
hardware; and
documentation corresponding to software and hardware.

11. The system of claim 8, the plurality of artifacts comprising adapters to enable the business solution to access a third party vendor.

12. The system of claim 8, wherein the plurality of assets are defined by reusable asset specification.

13. The system of claim 8, logic, stored on the memory for execution on the processor, for updating menus and pallets associated with the tooling in conjunction with the reconfiguration of the tooling.

14. The system of claim 8, wherein the assets repository is a remote access service (RAS) repository.

15. A computer programming product for business solution asset reconfiguration, comprising:
a memory; and
logic, stored on the memory for execution on a processor, for:
identifying an asset for incorporation into a business model;
downloading the asset from an asset repository;
disassembling the asset into a plurality of artifacts;
identifying an artifact of the plurality of artifacts for inclusion into the business model;
reconfiguring the business model to conform with the inclusion of the identified artifact;
incorporating the identified artifact into a business solution represented by the business model; and
transmitting a representation of the business solution to a display.

16. The computer programming product of claim 15, further comprising logic, stored on the memory for execution on the processor, for:
determining whether or not the downloaded asset is an operational model asset type;
if the asset is an operational model asset type, performing the disassembling, identifying, reconfiguring and incorporating; and
otherwise, if the asset is not an operational model asset type, not performing the disassembling, identifying, reconfiguring and incorporating.

17. The computer programming product of claim 15, the plurality of artifacts comprising:
software;
hardware; and
documentation corresponding to software and hardware.

18. The computer programming product of claim 15, the plurality of artifacts comprising adapters to enable the business solution to access a third party vendor.

19. The computer programming product of claim 15, wherein the plurality of assets are defined by reusable asset specification.

20. The computer programming product of claim 15, logic, stored on the memory for execution on the processor, for updating menus and pallets associated with the tooling in conjunction with the reconfiguration of the tooling.
